(19) United States
(12) Patent Application Publication
(10) Pub. No.: US 2010/0290170 A1
(43) Pub. Date: Nov. 18, 2010

(54) Power Controller, Electronic Apparatus, and Control Method of Power Controller

(76) Inventor: Takeshi Kumagaya, Hachioji-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/605,037

(22) Filed: Oct. 23, 2009

(30) Foreign Application Priority Data
May 15, 2009 (JP) 2009-118623

(51) Int. Cl. H01H 47/00

(52) U.S. Cl. 361/160

(57) ABSTRACT

According to an aspect of the invention, a power controller includes: a latching relay module configured to be connected to an external power source; a first monitoring module configured to monitor first power input from the external power source and configured to output a first monitoring result; a second monitoring module configured to monitor second power output from a power module connected to a downstream of the latching relay module and configured to output a second monitoring result; and a control module configured to instruct the latching relay module to turn on based on the first monitoring result and the second monitoring result.

### CROSS-REFERENCE TO RELATED APPLICATIONS

This application is based upon and claims the benefit of priority from Japanese Patent Application No. 2009-118623, filed May 15, 2009, the entire contents of which are incorporated herein by reference.

### BACKGROUND

1. Field

The present invention relates to a power controller having a latching relay circuit.

2. Description of the Related Art

In recent years, power control circuits have spread which control the power of electric equipment or the like by remote control.

JP-A-10-327543 discloses a power control circuit having a latching relay circuit. More specifically, JP-A-10-327543 discloses a technique of controlling a switch which controls the supply of power using a pulse detection circuit which recognizes a power on/off signal transmitted from a remote controller.

JP-A-10-327543 also discloses that when noise occurs on a signal line for an on/off signal transmitted from a remote controller, a latching relay operates erroneously and power is supplied to electric equipment erroneously.

Latching relay circuits have an advantage of low power consumption because they can switch on or off in response to a pulse. On the other hand, they are rendered unstable when subjected to vibration and they are prone to switch erroneously (i.e., they are turned on or off unexpectedly).

JP-A-10-327543 cannot solve the above matter that latching relay circuits are rendered unstable when subjected to vibration.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an electronic apparatus according to an embodiment of the present invention; and

FIG. 2 is an exemplary flowchart of a process which is executed by the electronic apparatus according to the embodiment.

### DETAILED DESCRIPTION

Various embodiments according to the invention will be described hereinafter with reference to the accompanying drawings. In general, according to one embodiment of the invention, d a power controller includes: a latching relay module configured to be connected to an external power source; a first monitoring module configured to monitor first power input from the external power source and configured to output a first monitoring result; a second monitoring module configured to monitor second power output from a power module connected to a downstream of the latching relay module and configured to output a second monitoring result; and a control module configured to instruct the latching relay module to turn on based on the first monitoring result and the second monitoring result.

According to another aspect of the invention, a control method for a power controller having a latching relay module which is connected to an external power source, the method includes: monitoring first power input from the external power source; monitoring second power output from a power module connected to a downstream of the latching relay module; receiving the monitoring result with respect to the first power and the second power; and instructing the latching relay circuit to turn on based on the received monitoring result.

An embodiment of the present invention will be hereinafter described with reference to the drawings.

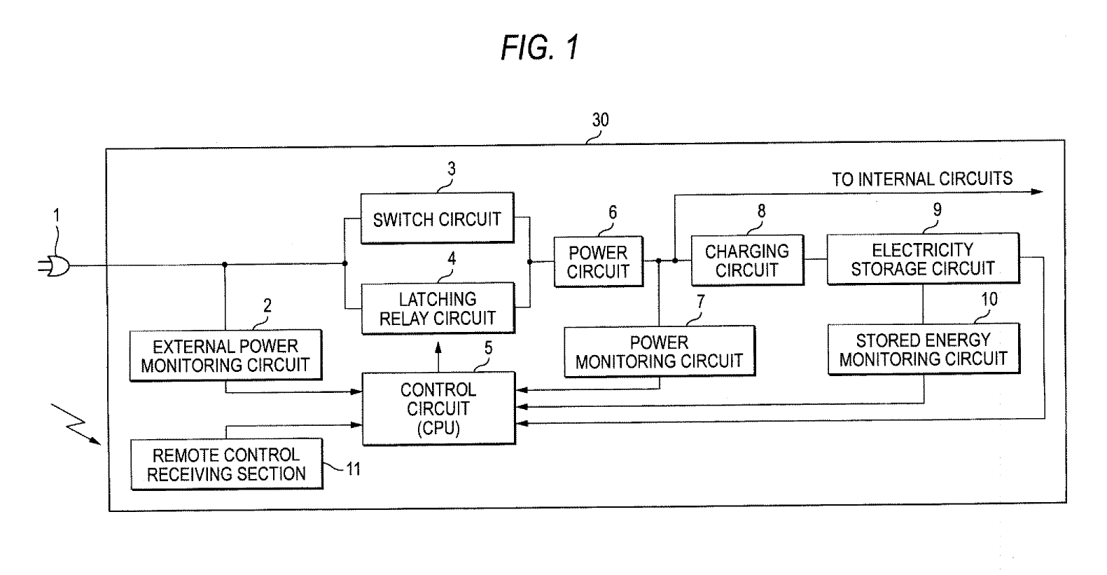

FIG. 1 is an exemplary block diagram of an electronic apparatus according to the embodiment of the invention. Reference numeral denotes an external power source; 2, an external power monitoring circuit; 3, a recovery switch circuit; 4, a latching relay circuit; 5, a control circuit (CPU); 6, a power circuit; 7, a parallel circuit output-side power monitoring circuit; 8, a charging circuit; 9, an electricity storage circuit; 10, a stored energy monitoring circuit; 11, a remote control receiving section; and 30, the electronic apparatus. The electronic apparatus 30 is a TV receiver, for example.

In the power control circuit according to the embodiment of the invention, the latching relay circuit 4 is parallel with the switch circuit 3.

The input side of the latching relay circuit 4 is connected to the external power source (AC power line) 1. The external power monitoring circuit 2 is connected to the external power source 1 and monitors its power. A monitoring result (whether the external power source 1 is on or off) is output to the control circuit 5.

The output side of the latching relay circuit 4 is connected to the output-side power monitoring circuit 7 and monitors the output-side power of the latching relay circuit 4. A monitoring result (whether the output-side power of the latching relay circuit 4 is on or off) is output to the control circuit 5.

The control circuit 5 receives the result of monitoring of the power of the external power source 1 which is output from the external power monitoring circuit 2 and the result of monitoring of the output-side power of the latching relay circuit 4 which is output from the output-side power monitoring circuit 7, and instructs, on the basis of those monitoring results, the latching relay circuit 4 how to operate.

More specifically, in the embodiment of the invention, the control circuit 5 instructs the latching relay circuit 4 to turn on.

First, the control circuit 5 instructs the latching relay circuit 4 to turn on, whereupon the latching relay circuit 4 is turned on. Then, the control circuit 5 receives both of a result of monitoring of the power of the external power source 1 which is output from the external power monitoring circuit 2 and a result of monitoring of the output-side power of the latching relay circuit 4 which is output from the output-side power monitoring circuit 7.

In a normal state, since the latching relay circuit 4 is kept on, the signals received by the control circuit 5 indicate that both of the power of the external power source 1 and the output-side power of the latching relay circuit 4 are on.

Assume that in this state the operation of the latching relay circuit 4 has become unstable because of, for example, an event that the user has touched the electronic apparatus (TV receiver) 30 strongly.

When the output-side power of the latching relay circuit 4 has become unstable, the output-side power of the latching relay circuit 4 may become off.

As described above, the control circuit 5 receives both of a result of monitoring of the power of the external power source 1 which is output from the external power monitoring circuit 2 and a result of monitoring of the output-side power of the latching relay circuit 4 which is output from the output-side power monitoring circuit 7.

Assume that because the operation of the latching relay circuit 4 has become unstable, the control circuit 5 receives, from the external power monitoring circuit 2, a monitoring result signal indicating that the power of the external power source 1 is on and also receives, from the output-side power monitoring circuit 7, a monitoring result signal indicating that the output-side power of the latching relay circuit 4 is off.

In this case, the control circuit 5 instructs the latching relay circuit 4 to turn on. That is, since the output-side power of the latching relay circuit 4 is off in spite of the fact that power is supplied from the external power source 1 (i.e., the power of the external power source 1 is on), the control circuit 5 judges that the operation of the latching relay circuit 4 is unstable (e.g., unresistible vibration has occurred) and instructs the latching relay circuit 4 to turn on.

In the embodiment of the invention, the control circuit 5 receives both of a result of monitoring of the power of the external power source 1 which is output from the external power monitoring circuit 2 and a result of monitoring of the output-side power of the latching relay circuit 4 which is output from the output-side power monitoring circuit 7 and instructs, on the basis of those monitoring results, the latching relay circuit 4 how to operate.

The external power source 1 is connected to the power circuit 6 via the latching relay circuit 4 and supplies power to the internal circuits via the power circuit 6.

The switch circuit 3 is provided to restore the power when the charge stored in the electricity storage circuit 9 has been discharged by more than a prescribed amount. The charging circuit 8 charges the electricity storage circuit 9 using the output of the power circuit 6.

The stored energy monitoring circuit 10 monitors the energy stored in the electricity storage circuit 9 and outputs monitoring result information to the control circuit 5. The remote control receiving section 11 receives a remote control signal from a remote controller or the like and outputs it to the control section 5.

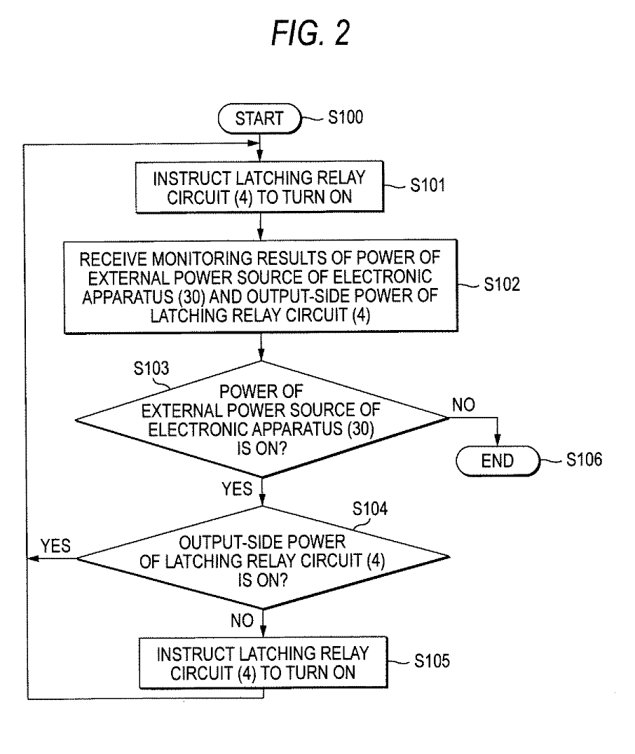

FIG. 2 is an exemplary flowchart of a process which is executed by the electronic apparatus 30 according to the embodiment of the invention.

The process will be described below for a case of installation of the electronic apparatus (TV receiver) 30.

For example, in a state that the latching relay circuit 4 is on at the time of installation of the electronic apparatus (TV receiver) 30, vibration of such a degree that the latching relay circuit 4 cannot resist it may occur because the user touches the electronic apparatus 30.

The process is started at step S100 and moves to step S101.

At step S101, the control circuit 5 instructs the latching relay circuit 4 to turn on. At step S102, the control circuit 5 receives a monitoring result of the power of the external power source 1 which is being supplied to the electronic apparatus 30 and a monitoring result of the output-stage power of the latching relay circuit 4.

At step S103, whether the power of the external power source I is on is detected. If it is detected that the power of the external power source 1 is on (S103: yes), the process moves to step S104. If it is not detected that the external power source 1 is on (S103: no), the process moves to step S106.

At step S104, whether the output-side power of the latching relay circuit 4 is on is detected. If it is detected that the output-side power of the latching relay circuit 4 is on (step S104: yes), the process returns to step S101. If it is not detected that the output-side power of the latching relay circuit 4 is on (i.e., the output-side power of the latching relay circuit 4 is off; step S104: no), the process moves to step S105.

At step S105, the control circuit 5 instructs the latching control circuit 4 to turn on. Then, the process returns to step S101 to repeat the above steps.

The process is finished at step S106.

According to the embodiment of the invention, when the latching relay circuit 4 has been turned off due to vibration or some other reason, the output-side power of the latching relay circuit 4 can be turned on by the control circuit 5's instructing the latching control circuit 4 to turn on.

The switch circuit 3 serves for recovery. For example, if the latching relay circuit 4 is turned off with the electricity storage circuit 9 storing no charge when the TV receiver 30 has been delivered to the user, no power is supplied from the external power source 1 and the latching relay circuit 4 cannot be turned on. In this situation, power is supplied from the external power source 1 bypassing the latching relay circuit 4 by turning on the switch circuit 3.

Having the role of controlling the latching relay circuit 4, the control circuit (CPU) 5 itself recognizes what state the latching relay circuit 4 should be in. Based on this recognition and monitoring results of the input-side power and the output-side power of the latching relay circuit 4, the control circuit 5 instructs the latching relay circuit 4 to turn on if the latching relay circuit 4 is turned off due to vibration or the like. It is the latching relay circuit 4 what is turned off and then on.

In this manner, the control circuit (CPU) 5 can turn on the latching relay circuit 4.

Then, the electronic apparatus 30 is restored to the normal state. In the normal state, as for the signals received by the control circuit 5, since the latching relay circuit 4 is kept on, the signal that is output from the external power monitoring circuit 2 indicates that the power of the external power source 1 is on and the signal that is output from the output-side power monitoring circuit 7 indicates that the output-side power of the latching relay circuit 4 is on.

As described above, in the embodiment of the invention, the control circuit 5 receives a result of monitoring of the power of the external power source 1 which is output from the external power monitoring circuit 2 and a result of monitoring of the output-side power of the latching relay circuit 4 which is output from the output-side power monitoring circuit 7 and instructs the latching relay circuit 4 to turn on based on both monitoring results.

With the above configuration, the embodiment provides the advantage that even if the latching relay circuit 4 is turned off due to vibration or the like, the control circuit 5 returns the latching relay circuit 4 to the on-state and allows it to operate stably thereafter without requiring the user to make any manipulation. The embodiment thus provides an advantage that a power control circuit and an electronic circuit each having a latching relay circuit capable of stable operation can be provided.

Although in the above description is directed to the TV receiver 30 as an example of the electronic apparatus 30, the application fields of the invention are not limited to TV receivers. The invention can also be applied to general electronic apparatus such as DVD players and recorders and HDD recorders.

The invention is not limited to the above embodiment itself and can be embodied in such a manner that constituent elements are modified without departing from the spirit and scope of the invention.

As described with reference to the above embodiment, there is provided a power control circuit and an electronic apparatus which have a latching relay circuit capable of stable operation.

What is claimed is:

1. A power controller comprising:
a latching relay module configured to be connected to an external power source;
a first monitoring module configured to monitor first power input from the external power source and configured to output a first monitoring result;
a second monitoring module configured to monitor second power output from a power module connected to a downstream of the latching relay module and configured to output a second monitoring result; and
a control module configured to instruct the latching relay module to turn on based on the first monitoring result and the second monitoring result.

2. The power controller of claim 1, wherein the control module instructs the latching relay module to turn on when the first monitoring result indicates that the first power is supplied and the second monitoring result indicates that the second power is not supplied.

3. The power controller of claim 1, wherein the control circuit instructs the latching relay module to turn on based on the first monitoring result and the second monitoring result after instructing the latching relay module to turn on.

4. The power controller of claim 1, wherein an upstream of the latching relay module is connected to the external power source.

5. The power controller of claim 1 further comprising an electricity storage module configured to store the second power.

6. A control method for a power controller having a latching relay module which is connected to an external power source, the method comprising:
monitoring first power input from the external power source;
monitoring second power output from a power module connected to a downstream of the latching relay module;
receiving the monitoring result with respect to the first power and the second power; and
instructing the latching relay circuit to turn on based on the received monitoring result.

7. The control method of claim 6, wherein the instructing step is performed when the first power is supplied and the second power is not supplied.

8. The control method of claim 6, wherein the instructing step is performed after instructing the latching relay module to turn on.
